(19) United States
(12) Patent Application Publication
(10) Pub. No.: US 2015/0336315 A1
(43) Pub. Date: Nov. 26, 2015

(54) GAS REMOVAL VACUUM SYSTEM FOR USE WITH MOLD-IN-COLOR TOOLING

(71) Applicant: Ford Global Technologies, LLC, Dearborn, MI (US)

(72) Inventors: Robert D. Bedard, Allen Park, MI (US); Haoliang Michael Sun, Rochester Hills, MI (US); Derren Woods, Livonia, MI (US)

(21) Appl. No.: 14/715,289

(22) Filed: May 18, 2015

Related U.S. Application Data
(60) Provisional application No. 62/001,012, filed on May 20, 2014.

(51) Int. Cl. B29C 45/34; B29C 45/40; B29C 45/00

(52) U.S. Cl. CPC B29C 45/34; B29C 45/0025; B29C 45/401; B29C 2045/0034

(57) ABSTRACT

An injection molding tool for molded-in-color injection molding is disclosed. The tool includes a first mold half that includes a mold cavity, a second molding half that includes a molding core, an ejector pin fluidly associated with the first mold half, and a gas removal vacuum system fluidly associated with the ejector pin. The first mold half and the second mold half meet at a parting line that is free of vents. In operation, the two halves are brought together, defining a mold cavity therebetween. The gas removal vacuum system is activated to remove any air that is trapped between the two halves. Once the trapped air has been removed, an article-forming, polymerizable resin is injected into the mold cavity. The gas removal vacuum system is again operated to remove gas generated by the polymerizable resin during the injection process.

### TECHNICAL FIELD

The disclosed inventive concept relates to molded-in-color panels and molding systems for forming molded-in-color panels. More particularly, the disclosed inventive concept relates to a gas removal vacuum method and system used in association with injection molding tools to produce mold-in-color, high-touch, high-gloss and solid-color thermoplastic resin products that do not require a paint coat.

### BACKGROUND OF THE INVENTION

Panels formed from polymerized materials such as plastic are commonly used in vehicles, such as automotive vehicles. Such panels may be fitted to the interior or to the exterior of a vehicle. Such panels generally have two surfaces, a first surface that is generally visible to the observer and a surface that is not visible. The visible surface is generally referred to as a class-A surface. Because of their visibility, class-A surfaces should be free of defects and flaws. The other surface, the non-class-A surface, does not have to meet the same standard, provided that any flaws do not compromise the structural integrity of the part.

Because of the importance that the class-A surface panels be free of defects, such panels are not ordinarily injection-molded, compression-molded or vacuum-molded unless the vehicle panels are painted in a secondary painting operation that is undertaken to cover surface defects. However, painting the vehicle panel in a secondary painting operation requires additional time and cost. The paint applied to such panels is also susceptible to peeling, chipping, blistering and/or delamination.

In response to the problems associated with injection-molded panels that are painted in a post-production operation, manufacturers turned to molded-in-color plastic components. Molded-in-color components represent a lower cost option offering several advantages over injection-molded panels that require painting, including a lower environmental impact due to the recyclability of paint-free parts and avoided production of volatile organic compounds generally associated with painting.

However, while providing improvements over injection-molded components that require subsequent painting, today's methods and systems related to injection molded, molded-in-color components are not without their limitations and challenges. One persistent problem is the presence of the parting line flash that exceeds acceptable limits. For example, some door switch bezels formed according to known techniques used in the production of molded-in-color components exhibit parting line flash above the preferred and recommended maximum threshold of 0.25 mm, thus resulting in components having unsatisfactory class-A surface finishes.

These problems are the result of two diametrically opposed but inherent characteristics of the thermoplastic resin used to produce components such as the above-referenced bezels: High off-gassing and low viscosity. The known approach to managing the high off-gassing problem is to include one or more vents at the parting line that allow the gas to exhaust the mold. While technically solving the problem, the use of vents is less than ideal. If, on the one hand, the gas does not leave the mold in time, it can manifest itself as surface appearance defects such as bubbles and streaks, in addition to burning the periphery of the molded part while creating a white, hazy discoloration along the parting line. On the other hand, if sufficient venting is provided at the parting line to allow the gas to leave the mold in time, the resin will tend to seep into the vent openings due to its inherent low viscosity, resulting in excessive flash and an unsatisfactory class-A surface finish.

Accordingly, as in many areas of automotive production technology, there is room for improvement in the art of forming molded-in-color components from injection-molded systems.

### SUMMARY OF THE INVENTION

The disclosed inventive concept overcomes the problems of known systems and methods of removing fluids from an injection molding tool during the production of a molded-in-color polymerized article. Particularly, the system of the disclosed inventive concept includes an injection molding tool having a first mold half that includes a mold cavity, a second molding half that includes a molding core, an ejector pin fluidly associated with the first mold half, and a gas removal vacuum system fluidly associated with the ejector pin. The first mold half and the second mold half meet at a parting line that is free of vents.

In operation, the two halves are brought together, defining a mold cavity therebetween. The gas removal vacuum system is activated to remove any air that is trapped between the two halves. Once the trapped air has been removed, an article-forming, polymerizable resin is injected into the mold cavity. The gas removal vacuum system is again operated to remove gas generated by the polymerizable resin during the injection process.

Since the vacuum system removes the gas generated by the resin during the injection process, there is no longer a need to have parting line vents. If no parting line vents are required, then there is no opportunity for the resin to seep through. Furthermore, by tightly stone-spotting the parting line, the need for a separate rubber seal (as is used in conventional vacuum systems) is mitigated. In addition, since the vacuum system removes the gas generated by the resin during the injection process, gas “burn” can no longer occur, and the parting line can be tightly stone-spotted, which will not allow the resin to seep through, therefore completely eliminating flash at the parting line.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a diagrammatic side elevational view of an injection molding tool according to the prior art; and

FIG. 2 is a diagrammatic side elevational view of an injection molding tool having a gas removal vacuum system according to the disclosed inventive concept.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

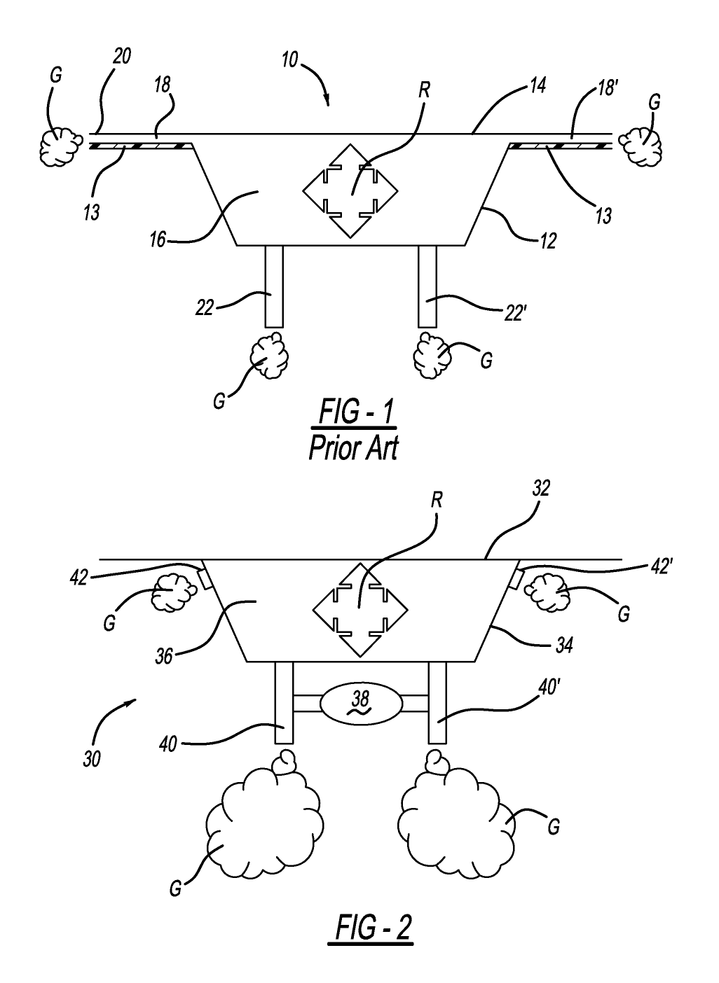

Referring to FIG. 1, a diagrammatic side elevational view of an injection molding tool according to the prior art, generally illustrated as 10. The injection molding tool 10 is capable of producing a molded-in-color panel (not shown).

The injection molding tool 10 includes a first mold half 12 and a second mold half 14. The first mold half 12 is referred to as a core while the second mold half 14 is referred to as a cavity. A separate rubber seal 13 is conventionally provided. The first mold half 12 or the core includes a substantial projection that is received within the second mold half 14 or cavity which itself has a substantial recess or space 16 for receiving the core. As is known in the art, the second mold half 14 may be movable relative to the first mold half 12.

The injection molding tool 10 further includes vents 18 and 18′ formed along a part line 20. The vents 18 and 18′ are provided to allow for the exhaust of gasses generated during the mold process. The injection molding tool 10 further may include vents formed within back-side features, such as with ejector pins 22 and 22′.

As noted above, the prior art injection molding tool 10 suffers from one of two problems. If the gas generated by the process does not exhaust the injection molding tool 10 through the vents 18 and 18′ or through the ejector pins 22 and 22′ in a timely manner, surface defects such as bubbles and streaks, in addition to burning the periphery of the molded part while creating a white, hazy discoloration along the parting line, may result, thus significantly compromising the class-A surface finish. But if the gas does manage to be exhausted through the vents 18 and 18′ or through the ejector pins 22 and 22′ in a timely manner, then the resin will tend to seep into the vents 18 and 18′ due to its inherent low viscosity, creating excessive flash and, again, resulting in an unsatisfactory class-A surface finish.

As the resin R fills the space between the second mold half 14 and the first mold half 12, both the air within the injection molding tool 19 and the gas that is generated by the resin R are released at the vents 18 and 18′ within the parting line 20 and at vents associated with ejector pins 22 and 22′.

The inventive concept disclosed herein overcomes the problems facing the prior art approach to producing molded-in-color components as produced using the injection molding tool 10. FIG. 2 illustrates a diagrammatic side elevational view of an injection molding tool according to the disclosed inventive concept, generally illustrated as 30, having a gas removal vacuum system.

The injection molding tool 30 produces molded-in-color plastic panels for a variety of purposes without class-A surface imperfections commonly associated with known systems. The panels produced by the injection molding tool 30 are suitable for use on either the interior or the exterior of a vehicle (not shown). Of course, any molded-in-color panel is contemplated within the scope of the disclosed inventive concept.

The injection molding tool 30 has a first mold half 32 and a second mold half 34. However, this is not intended as being limiting, as the injection molding tool 30 may have three or more mold portions, which collectively form the injection molding tool 30. Any number of mold portions is contemplated within the scope of the present invention.

According to the disclosed embodiment of the injection molding tool 30, the first mold half 32 is referred to as a cavity because it may have a substantial recess or space 36 for receiving the second mold half 34. The second mold half 34 is referred to as a core because the second mold half 34 has a substantial projection which is received in the cavity 32.

The second mold half or core 34 may be moveable relative to the first mold half or cavity 32. By providing a stationary cavity 32 and a moveable core 34, a vehicle panel may be retained within the injection molding tool 30 on the core 34 after molding the vehicle panel, which may be generally easily ejected or removed after the injection molding tool 30 is opened. It is also contemplated within the scope of the invention that the cavity 32 may be moveable while the core 34 is stationary. If three or more mold portions are employed, at least one mold portion may be moveable relative to at least a second mold portion.

To form the vehicle panel (not shown), a heated resin R is injected into the injection molding tool 30 through a resin inlet which may be a gate (not shown). The heated resin R may include colorant so that a secondary painting operation is not required. The heated resin R and the colorant may be separately injected into the injection molding tool 30. The resin R may have material properties comparable with a thermoplastic polyolefin (TPO) or a polycarbonate-acrylonitrile butadiene styrene (PC/ABS).

The resin may also contain a metallic additive (for example, metal flakes) and, in addition or as an alternative, a colorant for vehicle panel applications for use in the interior of the vehicle, for example. Using a metallic molded-in-color resin in a typical mold creates large amounts of surface defects, which are not visually appealing. The metallic molded-in-color resin may achieve a low gloss, quality, metallic appearance once injection-molded, compression-molded, or vacuum-molded. The resulting vehicle panel delivers an enhanced metallic appearance over paint and offers a low-cost option to using aluminum and/or decorative films.

The injection molding tool 30 includes a gas removal vacuum system 38 that comprises, for example, a vacuum pump, provided between ejector pins 40 and 40′. It is to be understood that the number and placement of the gas removal vacuum system 38 and the ejector pins 40 and 40′ may vary from the number and placement illustrated in FIG. 2, which is not intended as being limiting. For example, vents, such as vents 42 and 42′, may be additionally provided at strategic locations (such as at a position where resin paths meet) to assist in vacuuming out the air from the injection molding tool 30.

According to the method of the disclosed inventive concept, the air within the cavity is vacuumed out of the recess or space 36 defined between the first mold half or cavity 32 and the second mold half or core 34 prior to injection of the resin R. Once the air has been entirely or substantially removed, the resin R is injected into the injection molding tool 30. During the injection process, the gas generated by the resin R is vacuumed out of the injection molding tool 30 through the ejector pins 40 and 40′ by the gas removal vacuum system 38 and through the supplemental vents if present, such as vents 42 and 42′.

Since the gas removal vacuum system 38 removes the gas generated by the resin R during the injection process, gas “burn” can no longer occur, and the parting line can be tightly stone-spotted, which will not allow the resin to seep through, therefore completely eliminating flash at the parting line. The class-A surface of molded parts produced in this manner using the injection molding tool 30 of the disclosed inventive concept are free of defects.

The disclosed invention as set forth above overcomes the challenges faced by known windshield washer fluid and climate control systems for vehicles by either eliminating or significantly reducing the amount of windshield washer fluid odor present in the vehicle. However, one skilled in the art will readily recognize from such discussion, and from the accompanying drawings and claims that various changes, modifications and variations can be made therein without departing from the true spirit and fair scope of the invention as defined by the following claims.

What is claimed is:

1. An injection molding tool for use in the production of molded-in-color polymerized articles comprising:
a first mold half including a mold cavity;
a second mold half second mold half including a mold core;
an ejector pin fluidly associated with said first mold half; and
a gas removal vacuum system fluidly associated with said ejector pin.

2. The injection molding tool according to claim 1, wherein said ejector pin comprises at least two ejector pins fluidly associated with said gas removal vacuum system.

3. The injection molding tool according to claim 1, wherein the first mold half and the second mold half meet at a parting line.

4. The injection molding tool according to claim 3, wherein said parting line is free of vents.

5. The injection molding tool according to claim 3, wherein said parting line is tightly stone-spotted.

6. An injection molding tool for use in the production of molded-in-color polymerized articles comprising:
a first mold half;
a second mold half second mold half;
an ejector pin fluidly associated with said first mold half; and
a gas removal vacuum system fluidly associated with said ejector pin.

7. The injection molding tool according to claim 6, wherein said first mold half includes a mold cavity.

8. The injection molding tool according to claim 6, wherein said second mold half includes a mold core.

9. The injection molding tool according to claim 6, wherein said first mold half includes a mold cavity and said second mold half includes a mold core.

10. The injection molding tool according to claim 6, wherein said ejector pin comprises at least two ejector pins fluidly associated with said gas removal vacuum system.

11. The injection molding tool according to claim 6, wherein the first mold half and the second mold half meet at a parting line.

12. The injection molding tool according to claim 11, wherein said parting line is free of vents.

13. The injection molding tool according to claim 11, wherein said parting line is tightly stone-spotted.

14. A method for removing fluids from an injection molding tool during the production of a molded-in-color polymerized article comprising the steps of
forming an injection molding tool having first and second halves, an ejector pin fluidly associated with one of said halves, and a gas removal vacuum system;
placing said halves together;
vacuuming air from between said halves;
injecting a resin; and
vacuuming gas generated by said resin during injection.

15. The method for removing fluids from an injection molding tool during the production of a molded-in-color polymerized article according to claim 14 wherein further including at least one additional gas vent.

16. The method for removing fluids from an injection molding tool during the production of a molded-in-color polymerized article according to claim 14, wherein said gas removal system is fluidly associated with said ejector pin.

17. The method for removing fluids from an injection molding tool during the production of a molded-in-color polymerized article according to claim 14, wherein said first mold half includes a mold cavity.

18. The method for removing fluids from an injection molding tool during the production of a molded-in-color polymerized article according to claim 17, wherein said second mold half includes a mold core.

19. The method for removing fluids from an injection molding tool during the production of a molded-in-color polymerized article according to claim 18, wherein said ejector pin is fluidly attached to said first mold half and said gas removal vacuum system is fluidly attached to said ejector pin.

20. The method for removing fluids from an injection molding tool during the production of a molded-in-color polymerized article according to claim 19, wherein said first mold half and the second mold half meet at a parting line and wherein said parting line is free of vents.
